(19) United States
(12) Patent Application Publication
(10) Pub. No.: US 2014/0053787 A1
(43) Pub. Date: Feb. 27, 2014

(54) PET TOY HAVING HEMISPHERICAL ENDS

(71) Applicants: MARK J. OBLACK, Issaquah, WA (US); Kyle D. Burger, Seattle, WA (US)

(72) Inventors: MARK J. OBLACK, Issaquah, WA (US); Kyle D. Burger, Seattle, WA (US)

(73) Assignee: Canine Hardware Inc., Kent, WA (US)

(21) Appl. No.: 13/963,090

(22) Filed: Aug. 9, 2013

Related U.S. Application Data
(60) Provisional application No. 61/682,691, filed on Aug. 13, 2012.

(51) Int. Cl. A01K 11/00

(52) U.S. Cl. CPC A01K 15/026
USPC 119/709

(57) ABSTRACT

An improved pet toy is elongated and has resilient hemispherical ends. The pet toy additionally has fabric cover portion that extends generally between the ends, and further has a resilient core that is enclosed by the ends and the cover portion. The resilient and hemispherical nature of the ends enables the pet toy to bounce and tumble in a seemingly unpredictable fashion when it strikes a surface, which increases interest in the pet toy by an animal.

### CROSS-REFERENCE TO RELATED APPLICATION

The instant application claims priority from U.S. Provisional Patent Application Ser. No. 61/682,691 filed Aug. 13, 2012, the disclosures of which are incorporated herein by reference.

### BACKGROUND

1. Field

The disclosed and claimed concept relates generally to pet toys and, more particularly, to a fetch-type pet toy that bounces when it hits a surface.

2. Related Art

Numerous types of pet toys are known. Among such toys are fetch-type toys whereby a human throws a toy and the animal typically catches it, chases it, retrieves it, carries it, etc. While such toys have been generally effective for their intended purposes, they have not been without limitation.

Flying, buoyant throw toys are desirable for pet owners who wish to exercise their animals in varying environments with minimal self-exertion. Running or swimming with an animal is not always a viable option for a pet owner lacking the requisite physical capabilities consistent with such activities, as is the case for certain elderly or unconditioned pet owners. However, because running and swimming are both excellent forms of exercise for canines and other animals alike, it would be beneficial for less active pet owners to have a buoyant throw toy with maximal flight capability with which to exercise their pet.

Unfortunately, many throw toys today are not designed with sufficient structural integrity to withstand the repetitive biting force of an animal's teeth. Many known buoyant throw toys are too easily destroyed due to their low-density construction and lack of exterior protection. Likewise, many known durable, non-buoyant throw toys are of such heavy construction as to significantly reduce their flight capability. These heavier toys require a significant throwing force to propel them a distance necessary to sufficiently exercise an animal during a game of fetch. Further, throw toys with a plastic exterior construction can have hard, slick surfaces that are not optimally suited to be grasped by an animal's teeth. An improved pet toy would be desirable.

### SUMMARY

An improved pet toy is elongated and has resilient hemispherical ends. The pet toy additionally has fabric cover portion that extends generally between the ends, and further has a resilient core that is enclosed by the ends and the cover portion. The resilient and hemispherical nature of the ends enables the pet toy to bounce and tumble in a seemingly unpredictable fashion when it strikes a surface, which increases interest in the pet toy by an animal.

Accordingly, an aspect of the disclosed and claimed concept is to provide an improved pet toy that is configured to bounce in a seemingly unpredictable fashion when striking a surface.

Another aspect of the disclosed and claimed concept is to provide an improved pet toy that is comfortable for an animal to bite and chew yet is resistant to destruction due to such chewing.

These and other aspects of the disclosed and claimed concept are provided by an improved pet toy, the general nature of which can be stated as including a pair of ends that are of a hemispherical shape and that are formed of a resilient material, an elongated cover portion that extends between the ends and is formed at least in part of a number of interconnected fibers, and an elongated resilient core disposed generally between the ends and adjacent the cover portion.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a buoyant, ring-shaped, flying throw toy in accordance with a first embodiment of the disclosed and claimed concept;

FIG. 2 is a bottom-side view thereof;

FIG. 3 is a partial cross-sectional view as taken along line 3-3 of FIG. 2;

FIG. 4 is a perspective view of a buoyant, boomerang-shaped, flying throw toy in accordance with a second embodiment of the disclosed and claimed concept;

FIG. 5 is a cross-sectional perspective view thereof;

FIG. 6 is a perspective view of a buoyant, boat-fender-shaped throw toy in accordance with a third embodiment of the disclosed and claimed concept;

FIG. 7 is a cross-sectional view thereof;

FIG. 8 is a perspective view of a buoyant, disc-shaped, flying throw toy in accordance with an alternate embodiment of the disclosed and claimed concept;

FIG. 9 is a partial cross-sectional view as taken along line 9-9 of FIG. 8;

FIG. 10 is a front-side view of a buoyant, boomerang-shaped, flying throw toy in accordance with another alternative embodiment of the disclosed and claimed concept;

FIG. 11 is a front-side view of a buoyant, boomerang-shaped, flying throw toy in accordance with another alternative embodiment of the disclosed and claimed concept;

FIG. 12 is a front-side view of a buoyant, boomerang-shaped, flying throw toy in accordance with another alternative embodiment of the disclosed and claimed concept;

FIG. 13 is a front-side view of a buoyant, boomerang-shaped, flying throw toy in accordance with another alternative embodiment of the disclosed and claimed concept;

FIG. 14 is a front-side view of a buoyant, bone-shaped, flying throw toy in accordance with a further alternative embodiment of the disclosed and claimed concept;

FIG. 15 is a perspective view of an improved bumper-shaped throw toy in accordance with the disclosed and claimed concept;

FIG. 16 is a front view of the bumper-shaped throw toy shown in FIG. 15; and

FIG. 17 is a side view of the bumper-shaped throw toy shown in FIG. 15.

Similar numerals refer to similar parts throughout the specification.

### DETAILED DESCRIPTION

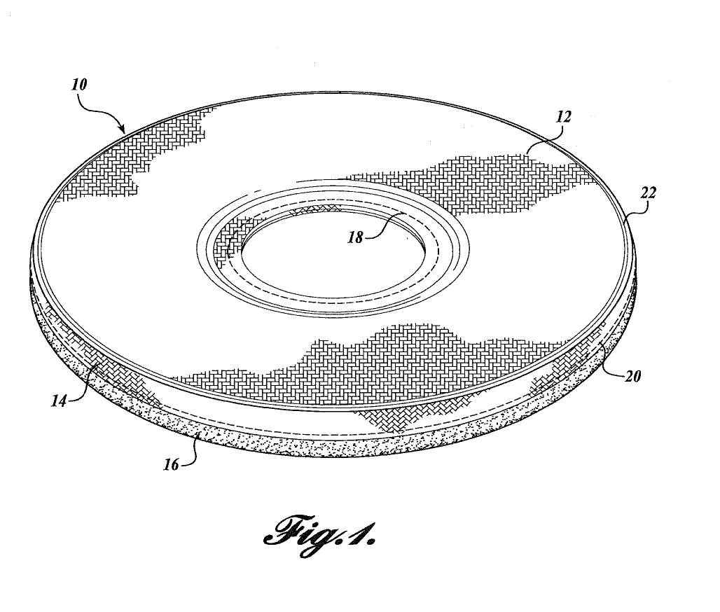

In accordance with a first embodiment of the disclosed and claimed concept, a flying, ring-shaped throw toy 10 that is capable of flight when propelled with a forward spinning force is illustrated in FIGS. 1-3. This throw toy 10 is comprised of three primary components: (i) a tear-resistant fabric covering component, in this embodiment comprising an assembly including an upper fabric component 12, a lower fabric component 14, and a sidewall fabric component 24, (ii) an abrasion-resistant pre-molded covering component 16 that in this embodiment is sewn to the lower and sidewall fabric components 14 and 24, and is positioned along a peripheral edge of the throw toy to gyroscopically stabilize the throw toy during flight, and (iii) an interior member 28 that is buoyant and that is completely covered or enclosed by the combined fabric and pre-molded covering components 12, 14, 24, and 16.

The fabric covering components 12, 14, and 24 are of a material such as a woven or non-woven fabric which comprises either natural or synthetic fibers, or combinations thereof, that are interconnected. In one embodiment the material from which the covering components 12, 14, and 24 are formed is a non-woven felted natural-fiber blend. In another embodiment the material is a woven nylon or polyester fabric. These materials are substantially resilient and able to withstand puncture and tear damage from an animal's teeth and claws.

The pre-molded covering component 16 is molded of an elastomeric material, for example synthetic rubber, natural rubber, or combinations thereof In one embodiment the pre-molded covering component 16 is made of a thermoset natural rubber. The pre-molded component 16 is formed to be substantially abrasion resistant to withstand ground impact associated with landings, is puncture-resistant to withstand the biting force of sharp animal teeth, and is self-healing to recover from deformation.

Self-healing properties include elastic-pliability combined with deformation-recovery. For example, when a self-healing object is stretched or deformed due to an exerted external biting force (e.g., the biting force of a dog's teeth), the object responds by returning to its original shape shortly after the force is removed. Self-healing recovery also includes fold-recovery, such that when the self-healing object is stretchably folded over onto itself, the object will unfold itself and return to its original shape when the folding force is removed.

The interior member 28 is of a material such as a closed-cell foam of sufficient density to be buoyant and to cause the throw toy 10 to float in water. Samples of closed-cell foam which may be used in the disclosed and claimed concept include an ethylene vinyl acetate (EVA) foam or a polyolefin foam.

Additional associated advantages of the materials from which the fabric covering components 12, 14, 24 and pre-molded covering component 16 are formed include grip and traction, such that the coverings are easily graspable by an animal's teeth and claws while the throw toy 10 is in flight, on the water, or lying at rest on the ground or other surface. Further benefits associated with the buoyant material from which the interior member 28 is formed include deformation-recovery, such that the interior member 28 can recover its shape after being temporarily deformed by an external biting or folding force.

It should be understood that the listing herein of selectable material types is not exhaustive, and many other material selections are feasible, while still allowing the disclosed and claimed concept to function as described. Further, the primary components and associated material types are consistent amongst all of the embodiments of the disclosed and claimed concept.

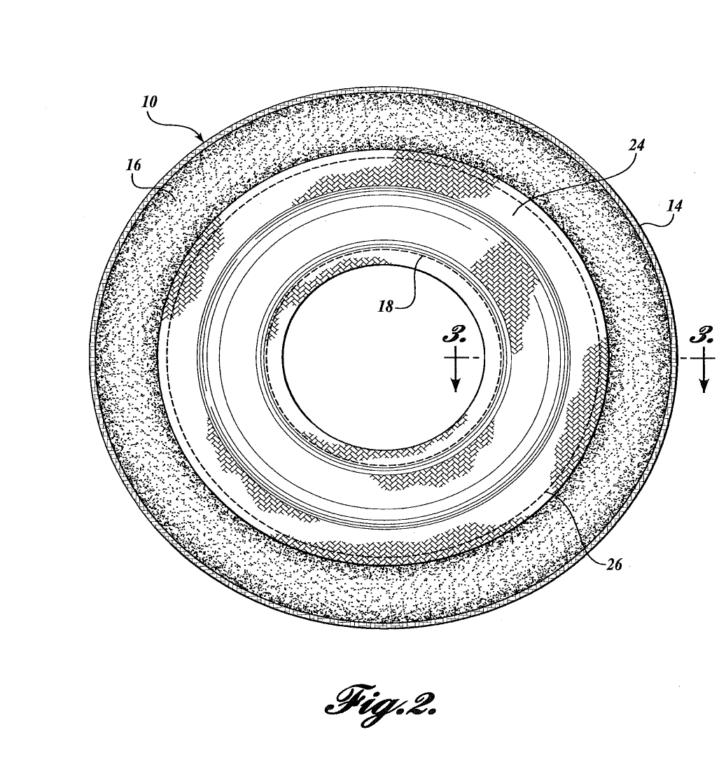

FIG. 1 is a perspective view that illustrates the ring-shaped throw toy 10 in accordance with the first embodiment of the disclosed and claimed concept. The throw toy 10 includes the fabric top component 12, which is sewn to the fabric bottom component 24 (illustrated in FIG. 2) with durable stitching 18. Further, the fabric side component 14 is sewn to the pre-molded covering component 16 along one edge, and to the tear-resistant fabric top component 12 along another edge, with durable stitching 20 and 22.

FIG. 2 illustrates a bottom view of the ring-shaped throw toy 10 wherein the fabric bottom component 24 is sewn to both the tear-resistant fabric top component 12 and the pre-molded component 16 with durable stitching 18 and 26.

FIG. 3 illustrates a partial cross-sectional view of the ring-shaped throw toy 10 wherein the interior member 28 is completely covered by the fabric and pre-molded components 12, 14, 24, and 16, which are joined together with stitching 18, 20, 22, and 26, such that none of the interior member 28 remains uncovered.

The stitching 18, 20, 22, and 26 may be provided using a material such as a synthetic thread or other material of sufficient tensile strength to resist breakage due to an external biting force. Samples of synthetic threads that are of sufficient tensile strength and which may be used in the disclosed and claimed concept include nylon or polyester threads, or combinations thereof. In accordance with one embodiment of the disclosed and claimed concept, a durable monofilament line is used as the stitching material type.

The interior member 28 in one embodiment is adhesively bonded to both the fabric and pre-molded components 12, 14, 24, and 16 in such a manner as to resist the interior member 28 from independently moving about within the combined covering components (adhesive element not shown). In accordance with one aspect of the invention, a fabric scrim or substrate may be provided between any of the covering components 12, 14, 24, and 16 and the interior member 28, to provide better bonding surfaces for promoting improved adhesion strength.

A scrim may be bonded to the pre-molded component 16 during a bonding process (which may be simultaneous with a molding process) to provide the pre-molded component with a superior surface with which to achieve a mechanical bond with the adhesive element. Samples of adhesive types, which may be used in accordance with the disclosed and claimed concept, include the following: hot glues, latent reactive adhesives, contact cements, and various other types of water-based or solvent-based adhesives. One advantage of the adhesion is to secure all three primary components together while at the same time resisting the interior member 28 from becoming misaligned within the pre-molded and fabric covering components 12, 14, 24, and 16.

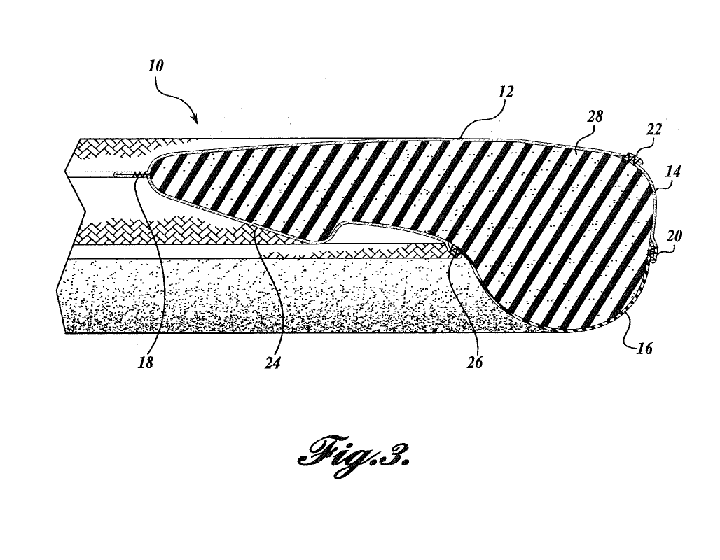

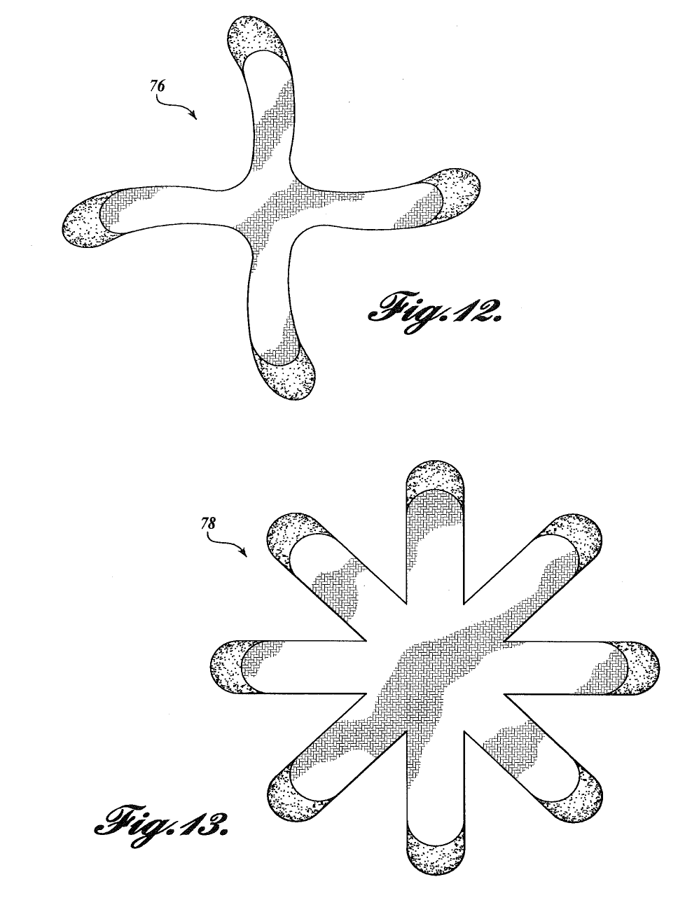

A further advantage of the adhesive layer is that when all of the components of the throw toy 10 are adhesively bonded together, they act in unison to better recover shape after a deformation occurs. This feature is particularly advantageous when the throw toy 10 is configured to include one or more elongated members, as seen in subsequent embodiments of the disclosed and claimed concept (e.g., FIGS. 4-7 and 10-17). In these embodiments, if interior adhesion were not present, an elongated member of the interior member could conceivably be compressed and misaligned internal to the sewn covering components such that the elongated member no longer correctly fills its designated extremity covering component. The adhesion acts to resist such misalignment and further tightly secures the covering components to the interior member to minimize aerodynamic resistance caused by loosely fitted covering components.

FIG. 4 is a perspective top-side view of a buoyant, boomerang-shaped throw toy 30 in accordance with the disclosed and claimed concept. The throw toy 30 comprises a tear-resistant fabric top covering component 32 sewn to a tear-resistant fabric bottom covering component 40 (illustrated in FIG. 5) and sewn to a pre-molded, abrasion-resistant frontal covering component 34 with durable stitching 36 and 38. FIG. 5 illustrates a cross-sectional view of the boomerang-shaped throw toy 30 of the depicted embodiment wherein the tear-resistant fabric bottom covering component 40 is sewn to both the tear-resistant fabric top covering component 32 and the abrasion-resistant pre-molded frontal covering component 34 with durable stitching 36 and 42. An interior member 44 that is buoyant is completely covered by the combination of the fabric components 32, 34 and the pre-molded component 40, such that none of the interior member 44 is exposed. In a current embodiment an adhesive layer (not expressly depicted herein) between the interior member 44 and both the fabric components 32, 34 and the pre-molded component 34 provides for a very tightly integrated product.

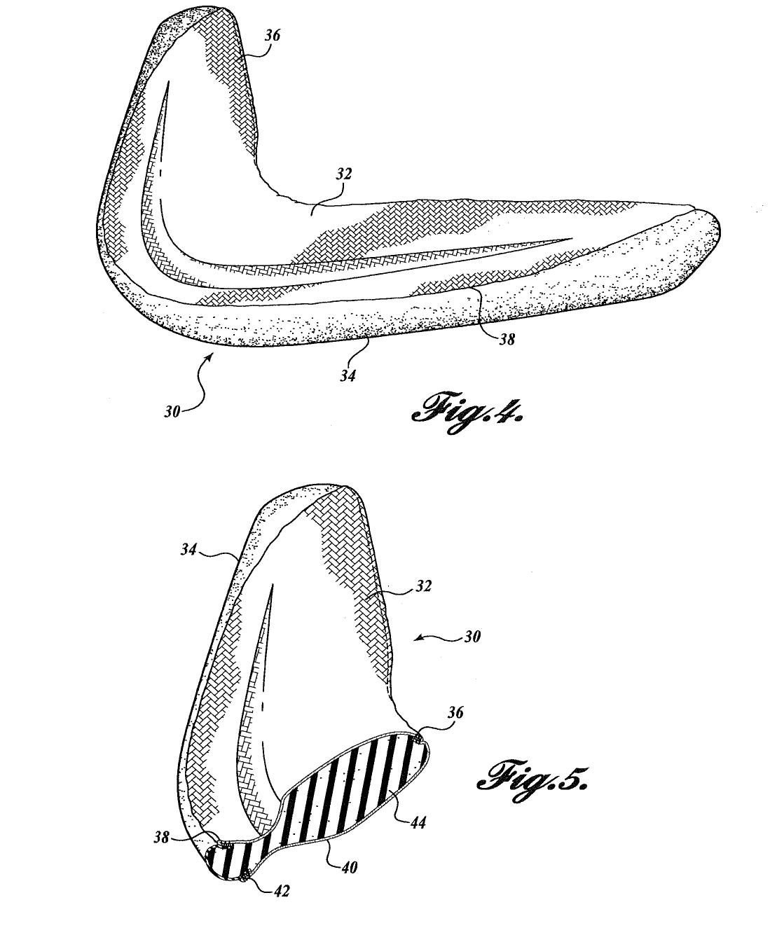

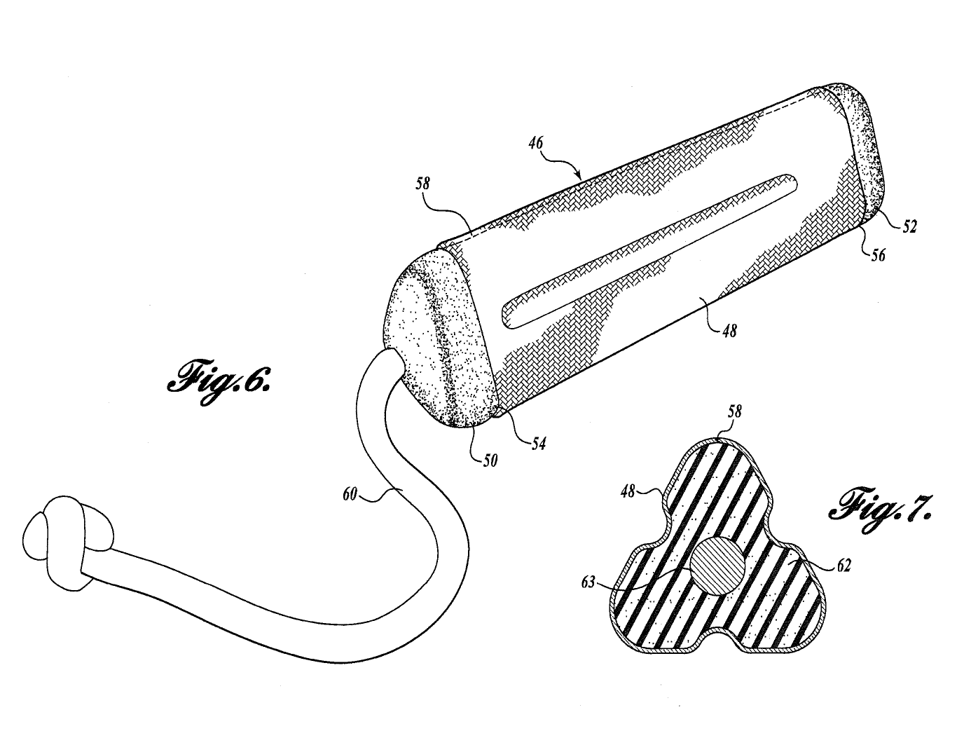

FIG. 6 illustrates a perspective view of a buoyant, boat-fender-shaped throw toy 46 in accordance with a third embodiment of the disclosed and claimed concept. The throw toy comprises a tear-resistant fabric covering component 48 sewn to two abrasion-resistant pre-molded cap covering components 50 and 52 with durable stitching 54 and 56. The fabric covering component 48 is also sewn to itself on a longitudinal seam with stitching 58 such that it conforms to a three-dimensional shape consistent with the shape of a buoyant interior member 62 (illustrated in FIG. 7).

Further in accordance with one embodiment of the disclosed and claimed concept, the cap covering component 50 is adaptively affixed to a rope 60 to more precisely resemble a traditional boat-fender object. FIG. 7 is a cross sectional view of the boat-fender-shaped throw toy 46 of the depicted embodiment showing the interior member 62 covered on three sides with the fabric covering component 48 and covered on two ends with the cap covering components 50 and 52, such that none of the interior member 62 remains uncovered. In accordance with one embodiment of the disclosed and claimed concept, the interior member 62 contains an elongated weighted element 63 to allow for more momentum when the throw toy 46 is thrown. Such additional mass may help to compensate for a lesser aerodynamic shape. An adhesive layer (not expressly depicted herein) may be provided between the interior member 62 and the fabric top covering component 48 and the pre-molded cap components 50 and 52.

The three embodiments disclosed above similarly comprise the following three primary components: at least one tear-resistant fabric covering component, at least one abrasion-resistant pre-molded covering component, and at least one buoyant foam interior member. These components are configured in such a way as to promote gyroscopic stability, impact-resistance, grip, and graspability for each distinct object shape of the first three embodiments. At least some of the objects are of a shape that is symmetric about an imaginary central axis and is configured to rotate about the imaginary central axis when thrown with a spinning force. In accordance with the illustrated configurations of the aforementioned embodiments, several alternative shapes can be realized while still maintaining the same material and design advantages described above.

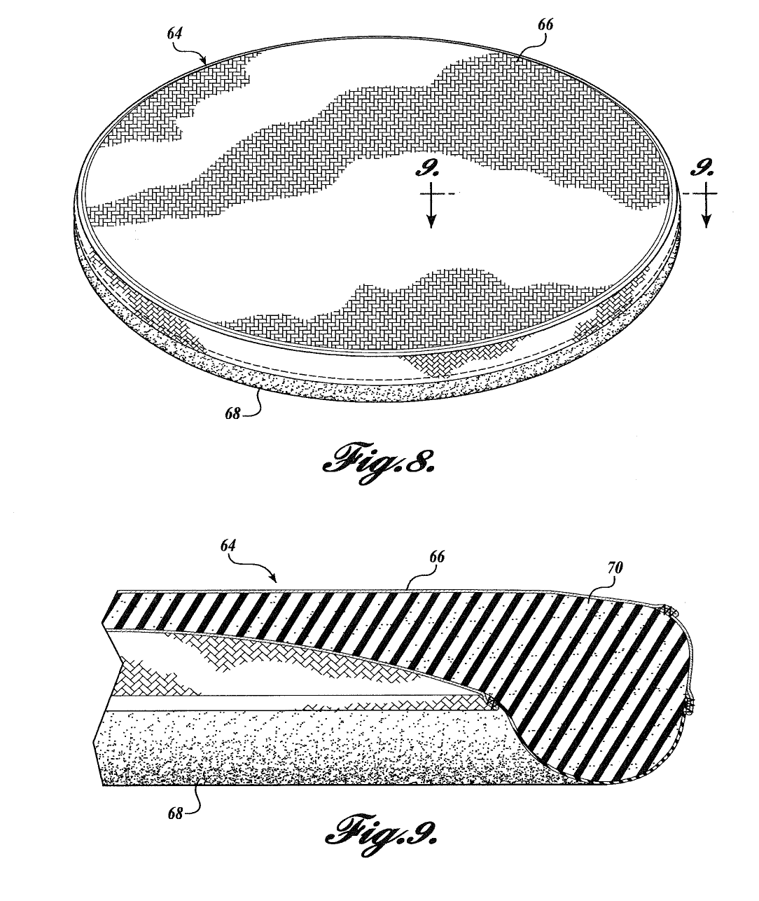

For example, the disc-shaped throw toy 64, illustrated in FIGS. 8-9, is similar in shape and component placement as the ring-shaped throw toy, illustrated in FIGS. 1-3, except that there is no center hole. In these similar embodiments, the pre-molded components 16 and 68 are situated on the bottom of the object shapes and around the peripheral edge to promote gyroscopic stability and flight time. It should be understood that the pre-molded components in the embodiments of the disclosed and claimed concept are of a higher density than those of the fabric and foam components. This weighted bottom-edge rim placement is beneficial for extended flight time because fabric and foam components alone may lack sufficient weight to provide sufficient momentum to the throw toy objects 10 and 64 when a spinning force is applied.

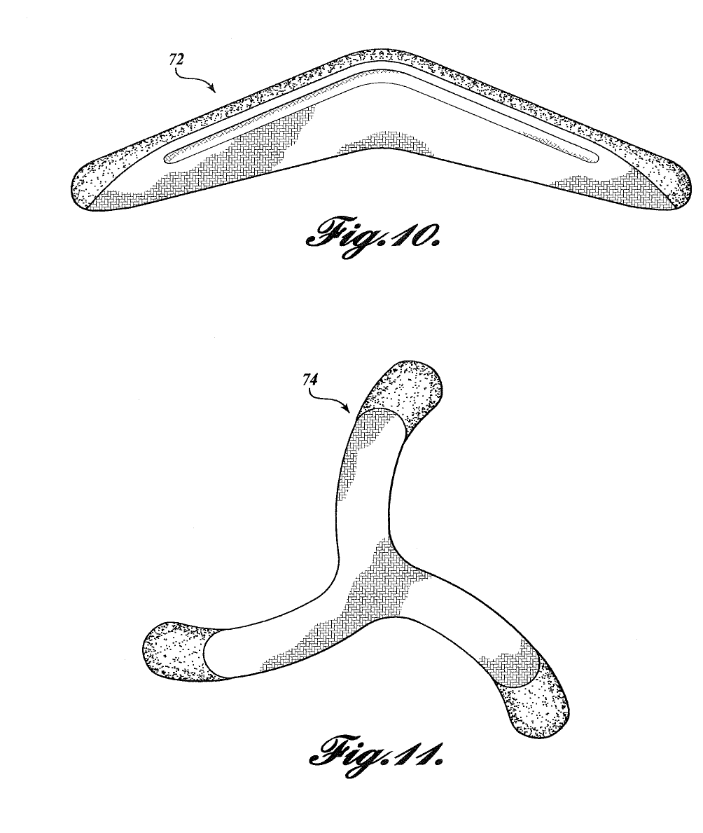

Likewise, the alternative boomerang-shaped throw toys 72-78, illustrated in FIGS. 10-13, have similar shape and component placement to the boomerang-shaped throw toy that is illustrated in FIGS. 4-5, with the exception that the alternative boomerang shaped throw toys 72-78 in FIGS. 11-13 have a greater number of elongated side members. The boomerang illustrated in FIG. 10 has a V-type shape similar to that of the V-type boomerang depicted in FIGS. 4-5, with the exception that the degree of bend is lesser and the length of the elongated side members is greater. This shape is particularly suited to extended flight time. In each of these additional embodiments, the pre-molded components are placed along the peripheral edge of the elongated side members in order to promote gyroscopic stability and flight time.

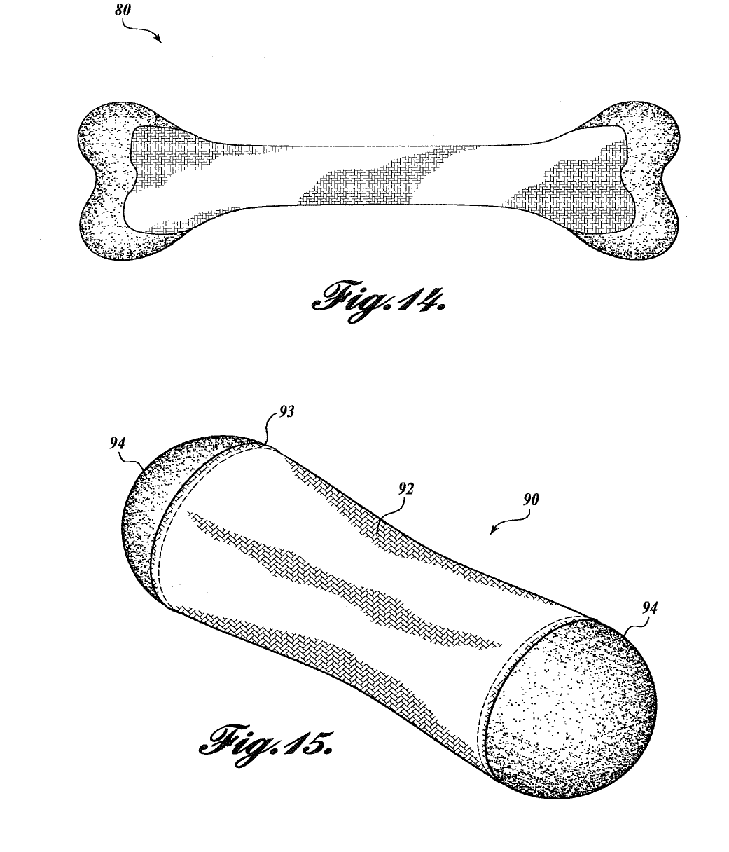

The alternative to the boat-fender-shaped throw toy, illustrated in FIGS. 6 and 7, is a bone-shaped throw toy 80 illustrated in FIG. 14. Both the boat-fender and the bone throw toys are configured to be thrown from one end such that the throw toy gyroscopically spins about an imaginary central axis when thrown. Similar to the boat-fender-shaped throw toy, optionally a buoyant interior member of the bone-shaped throw toy 80 may also contain an elongated weighted element to provide more momentum when the throw toy is in flight.

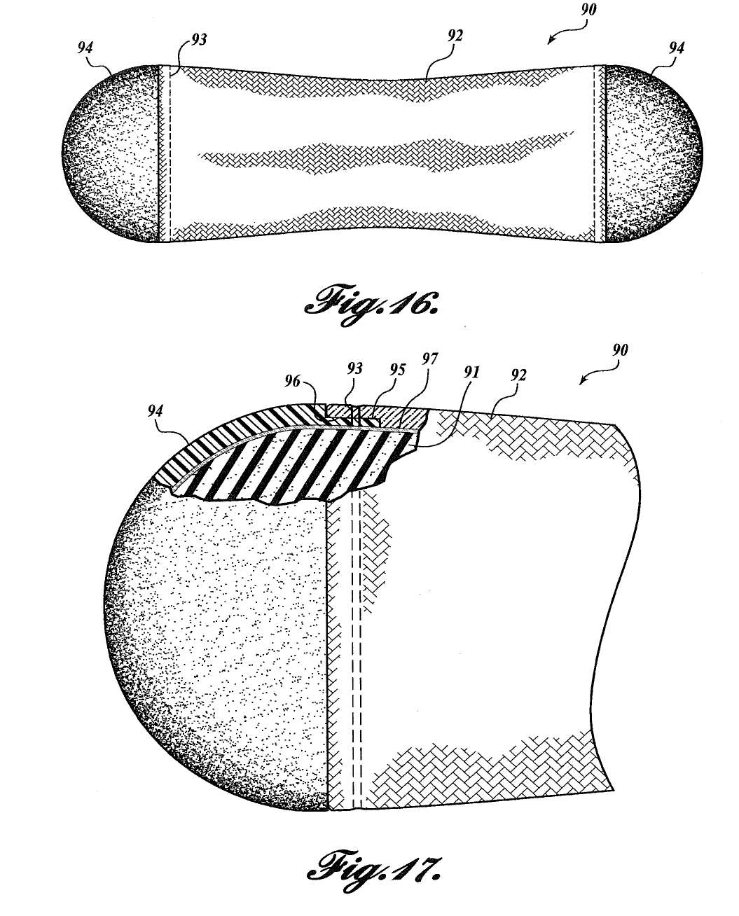

FIG. 15 is a perspective view of a bumper-shaped throw toy 90 in accordance with the disclosed and claimed concept, and FIG. 16 is a front view of the bumper-shaped throw toy 90. A partially cut-away, fragmentary front view is shown in FIG. 17. The bumper-shaped throw toy 90 is constructed in a similar manner to the previous embodiments and includes an elongated formed foam core 91 (FIG. 17), a fabric cover portion 92, and pair of hemispherical end caps 94.

The shape of the bumper-shaped throw toy 90 is maintained and reinforced by the use of pre-molded (pre-formed) elastomer (e.g., a natural or synthetic rubber) to form the hemispherical end caps 94, a tough fabric panel to form the cover portion 92 between the end caps 94, and a pre-molded or otherwise pre-formed polymer foam core 91 which may be formed from a closed cell foam. The fabric cover portion 92 and end caps 94 are sewn together, and cooperatively enclose the foam core 91, which is shaped to substantially fill the volume enclosed by the fabric cover portion 92 and end caps 94. In the depicted embodiment, each end cap 94 includes a relatively thin flange 95 that underlies an end of the fabric portion 92, and is engaged by the stitching 93. As seen in FIG. 17, a recess 96 of the fabric portion 92 fits over the relatively thin flange 95 of the hemispherical end caps 94, and these components are bonded together into a single reinforced toroidal structure. An adhesive or adhesive substrate 97 substantially surrounds the core 91 and is disposed between the core 91 and the fabric cover portion 92 and end caps 94.

This reinforced structure, because of the materials selected, is of sufficient mass to enable outdoor play including rolling along uneven ground, while being relatively light in weight. The bumper-shaped throw toy 90 is formed of soft and compliant materials and is thus pliable and deformable. However, the toy 90 will return to an original shape when a deforming force is removed, i.e., it exhibits shape recovery. The molded (or otherwise pre-formed) rubber end caps 94 provide resilient spring and bounce characteristics for the toy 90.

The bumper-shaped throw toy 90 with the rubber end caps 94 has been found to have unique playing functionality due to the hemispherical shape and opposing disposition of the end caps 94, which produce a unique and unpredictable tumbling action when the toy 90 is thrown. The unique tumbling action may also be caused in part by the particular construction of the foam core 91 being tightly and adhesively coupled with the fabric portion 92 and the end caps 94. The unique tumbling action is believed to add enjoyment as well as reflex training when the toy 90 is used to play with or to exercise pets.

The bumper-shaped throw toy 90 may have an axial length of between 8 inches and 12 inches and a diameter of between 2.5 inches and 3.5 inches. In the depicted embodiment the center body of the toy 90 is of a circular cross-sectional shape that narrows in diameter towards the center of the toy 90.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A pet toy comprising:
a pair of ends that are of a hemispherical shape and that are formed of a resilient material;
an elongated cover portion that extends between the ends and is formed at least in part of a number of interconnected fibers; and
an elongated resilient core disposed generally between the ends and adjacent the cover portion.

2. The pet toy of claim 1 wherein the ends face away from each other.

3. The pet toy of claim 2 wherein the ends and the cover portion are directly affixed to the core.

4. The pet toy of claim 3 wherein the ends and the cover portion are directly affixed to one another.

5. The pet toy of claim 1 wherein the pet toy is elongated and is of a length that is substantially greater than its width.

6. The pet toy of claim 1 wherein the ends and the cover portion are directly affixed to one another and wherein, for each end of the pair of ends, the end and the portion of the cover portion connected therewith are together in the general shape of a toroid.

7. The pet toy of claim 6 wherein each end of the pair of ends includes a flange that underlies the portion of the cover portion connected therewith.

8. The pet toy of claim 1 wherein the core is enclosed by the ends and the cover portion.

9. The pet toy of claim 1 wherein the core and the cover portion adjacent thereto are of a substantially circular shape transverse to the direction of elongation, and wherein the circular shape at a location generally midway between the ends is of a smaller diameter than the circular shape at a location adjacent an end of the pair of ends.

10. The pet toy of claim 9 wherein the circular shape tapers between each end and the location generally midway between the ends.
